(19) United States
(12) Patent Application Publication
(10) Pub. No.: US 2026/0320852 A1
(43) Pub. Date: Oct. 15, 2026

(54) IMAGE-TO-VIDEO GENERATION USING LOCATIONS IN DIGITAL IMAGES

(71) Applicant: Adobe Inc., San Jose, CA (US)

(72) Inventors: Hui Qu, Santa Clara, CA (US); Saeid Motiian, San Francisco, CA (US); Ratheesh Kalarot, San Jose, CA (US); Krishna Kumar Singh, San Jose, CA (US); Jinxin Zhou, Columbus, OH (US)

(73) Assignee: Adobe Inc., San Jose, CA (US)

(21) Appl. No.: 19/178,616

(22) Filed: Apr. 14, 2025

(51) Int. Cl. G06T 11/00; G06N 3/0455; G06T 7/246

(52) U.S. Cl. CPC G06T 11/00; G06N 3/0455; G06T 7/248; G06T 2207/30241

(57) ABSTRACT

In implementations of techniques and systems for bounding box motion control for image-to-video generation, a processing device receives an input defining an initial location in an initial video frame and a target location in a target video frame. The processing device determines, for a set of intermediary video frames, a set of intermediary locations as exhibiting movement between the initial location and the target location. The processing device generates a digital video that includes an object as disposed at the initial location in the initial video frame, the set of intermediary locations in the set of intermediary video frames, and the target location in the target video frame using a transformer-based diffusion model.

### BACKGROUND

Systems implement machine learning models to generate videos from one or more input images and/or text prompts. A popular machine learning model used for image-to-video generation is referred to as a diffusion model. Diffusion models work by iteratively adding noise to data during a forward process and then learn to recover the data by denoising the data during a reverse process.

### SUMMARY

Image-to-video generation is described which is based on use of locations in digital images. In one or more examples, an initial location in an initial video frame and a target location in a target video frame are received as inputs by an image-to-video generator. Based on the inputs, a set of intermediary locations of a set of intermediary video frames exhibiting movement between the initial location and the target location is determined by the image-to-video generator. Additionally, a digital video is generated by the image-to-video generator using a transformer-based diffusion model. The digital video includes an object as disposed at the initial location in the initial video frame, the set of intermediary locations in the set of intermediary video frames, and the target location in the target video frame.

This Summary introduces a simplified selection of concepts described below in the Detailed Description. As such, this Summary is not intended to identify essential features of the claimed subject matter or to aid determining its scope.

### BRIEF DESCRIPTION OF THE DRAWINGS

The Detailed Description is described with reference to the accompanying FIGS.

Entities represented in the FIGS. are indicative of one or more entities and thus reference is made interchangeably to single or plural forms of the entities in the discussion.

FIG. 1 illustrates an example of an environment that supports image-to-video generation using locations in digital images in accordance with aspects of the present disclosure.

FIG. 2A illustrates an example of a flow of one or more steps for generating locations in latent space that supports image-to-video generation using locations in digital images in accordance with aspects of the present disclosure.

FIG. 2B illustrates an example of a location layout in pixel space that supports image-to-video generation using locations in digital images in accordance with aspects of the present disclosure.

FIG. 2C illustrates an example of a location layout in latent space that supports image-to-video generation using locations in digital images in accordance with aspects of the present disclosure.

FIG. 3 illustrates an example of a model architecture that supports image-to-video generation using locations in digital images in accordance with aspects of the present disclosure.

FIG. 4 illustrates an example of a component diagram that supports image-to-video generation using locations in digital images in accordance with aspects of the present disclosure.

FIG. 5 illustrates an example of a procedure that supports image-to-video generation using locations in digital images in accordance with aspects of the present disclosure.

FIG. 6 illustrates an example of a guided diffusion model that supports image-to-video generation using locations in digital images in accordance with aspects of the present disclosure.

FIG. 7 illustrates an example of a method that supports image-to-video generation using locations in digital images in accordance with aspects of the present disclosure.

FIG. 8 illustrates an example of a diffusion process that supports image-to-video generation using locations in digital images in accordance with aspects of the present disclosure.

FIG. 9 illustrates an example of a procedure that supports image-to-video generation using locations in digital images in accordance with aspects of the present disclosure.

FIG. 10 illustrates an example of a method that supports image-to-video generation using locations in digital images in accordance with aspects of the present disclosure.

FIG. 11 illustrates an example of a system that supports image-to-video generation using locations in digital images in accordance with aspects of the present disclosure.

### DETAILED DESCRIPTION

### Overview

Conventional techniques that rely on machine-learning models to generate a digital video are confronted with numerous technical challenges. Conventional techniques, for instance, do not support precise positioning of objects within digital frames of the digital video. Further, conventional techniques often fail when confronted with a task of inserting a specific object within a designated area for objects that are not included in key frames of the digital video. As a result, conventional digital video generation techniques often fail in an intended purpose, produce visual artifacts and inaccuracies, and a corresponding inefficient use of computational resources.

Accordingly, to address these and other technical challenges techniques are described that support accurate and concise motion control in image-to-video diffusion models. In one or more examples, the techniques described herein propose a latent mask mechanism that integrates location-based constraints into transformer-based diffusion models. An image-to-video generator, for instance, first identifies an initial location in an initial video frame and a target location in a target video frame. The initial location represents a starting position of an object, and the target location represents an ending position of the object.

Using the initial location and the target location, the image-to-video generator generates a set of intermediary locations for a set of intermediary video frames (e.g., video frames between the initial video frame and the target video frame). Further, the image-to-(1 video generator inputs the locations (e.g., the initial location, the target location, and the set of intermediary locations) into the transformer-based diffusion model and generates a digital video with an object that is disposed within the video frames (e.g., the initial video frame, the set of intermediary video frames, and the target video frame) based on the locations. In some implementations, the image-to-video generator implements a latent mask mechanism. That is, the image-to-video generator projects the locations in latent space using an encoder prior to the diffusion process. The latent mask mechanism explicitly imposes location constraints on the objects. Further, the latent mask mechanism decreases memory resources needed for training the transformer-based diffusion model when compared to other techniques.

The techniques as described herein that are implemented by the image-to-video generator support enhanced motion control for transformer-based image-to-video diffusion models. These techniques build on image-to-video diffusion models by introducing locations (or, in some examples, bounding boxes) that correspond to specific positions and shapes of objects in each video frame of the digital video generated by the transformer-based image-to-video diffusion models increasing precision and flexibility in object manipulation.

The following discussion describes an example environment that employs the techniques described herein.

### Example Digital Video Generation Environment

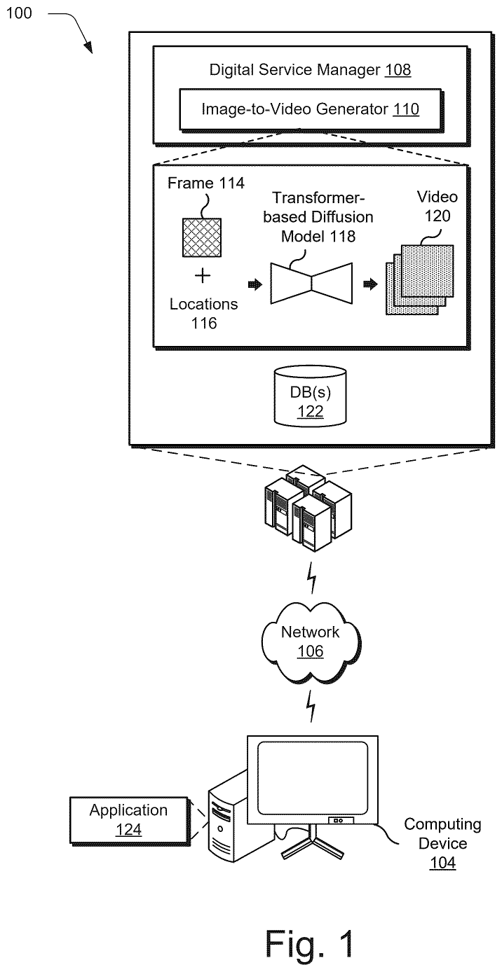

FIG. 1 illustrates an example of an environment 100 that supports image-to-video generation using locations in digital images. As illustrated in FIG. 1, the environment 100 includes a digital provider system 102, a computing device 104, and a network 106. In some implementations, each component of the environment 100 communicates via the network 106. The network 106 is any suitable network over which the components can communicate. For example, the network 106 includes the internet.

In one example, the computing device 104 is an example of a client device and is configured in a variety of ways. For example, the computing device 104 is configured as a desktop computer, a laptop computer, a mobile device, an IoT device, a wearable device (e.g., a smart watch, a ring, or smart glasses), an AR/VR device (e.g., the smart glasses), a server, etc. As such, the computing device 104 ranges from a full resource device with substantial memory and memory resources to a low-resource device with limited memory and processing resources. Although the computing device 104 is illustrated as a singular device, it is understood that the computing device 104 is also representative of multiple of different devices, e.g., multiple servers of a server farm. The computing device 104 is capable of displaying content (e.g., text, images, or video) received from the digital provider system 102.

The digital provider system 102 is an example of one or more servers and generates, stores, receives, or transmits electronic data, such as digital text, digital video, digital images, digital audio, metadata, etc. As shown in FIG. 1, the digital provider system 102 includes an image-to-video generator 110 as part of a digital service manager 108. The digital service manager 108 can communicate with the computing device 104 and/or other devices to provide digital content such as digital text, digital video, digital images, digital audio, metadata, etc. to the image-to-video generator 110. In some implementations, the digital service manager 108 can refer to a digital agent system, digital content campaign system (e.g., a system for selecting and providing customized digital videos to client devices simultaneously accessing websites or other digital assets) and/or a system for facilitating dialogue between the image-to-video generator 110 and one or more users.

Although FIG. 1 depicts the image-to-video generator 110 located on the digital provider system 102, the image-to-video generator 110 is implemented by (e.g., located entirely or in part) on one or more other components of the environment 100. For example, the image-to-video generator is implemented by the computing device 104 and/or a third-party device and/or a third-party server, e.g., a server associated with a business such as a restaurant chain, a department store, a digital content publisher, etc.

In some implementations, the computing device 104 includes an application 124. The application 124 is configurable as a web application or a native application installed on the computing device 104, e.g., a mobile application, a desktop application, etc. The application 124 is configurable to interface with the image-to-video generator 110 to receive digital content (e.g., videos) and display the digital content, e.g., on an illustrated display device. In addition, the application 124 can collect and provide information associated with a user to the image-to-video generator 110.

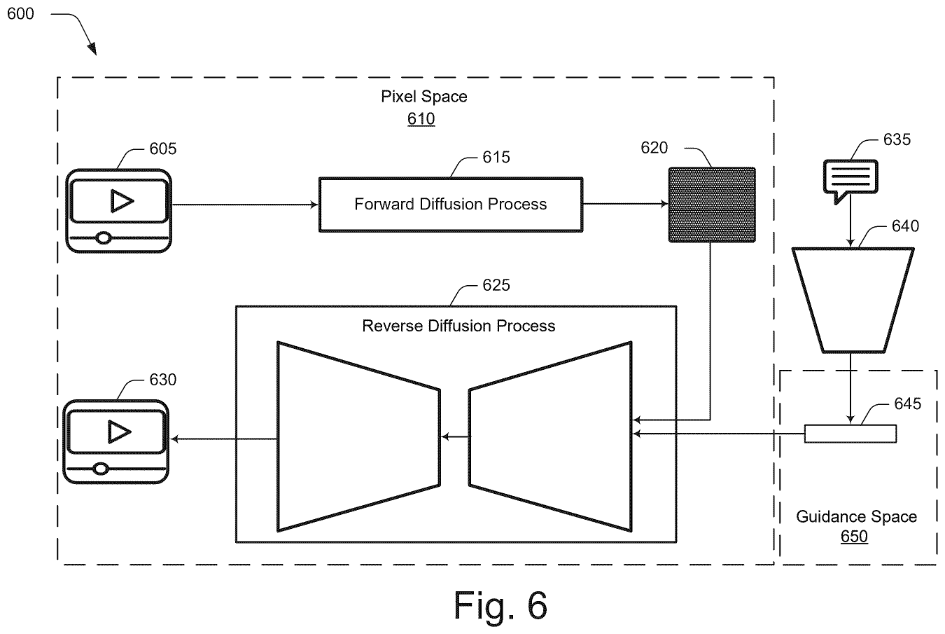

The image-to-video generator 110 is configured to convert one or more digital images into a digital video. To provide such functionality, the image-to-video generator 110 supports a transformer-based diffusion model 118. A diffusion model is a type of generative model that is designed to gradually add noise to data through a diffusion process and learn to reverse the diffusion process to construct the desired data from the noise. The diffusion process includes a forward process and a reverse process. During the forward process, the diffusion model gradually guides data towards a simple noise distribution. In the reverse process, the diffusion model gradually removes noise to recover the original data. In some implementations, the diffusion process takes place in latent space, e.g., latent diffusion. That is, prior to the diffusion process, input data is compressed into low-dimensional latent representations using a variational autoencoder (VAE) and, after the diffusion process, the latent representations are decoded to original data through a decoder. Additional details of the diffusion model are described with reference to FIGS. 6-10.

The transformer-based diffusion model 118 is a diffusion model that is combined with a transformer architecture. A transformer is a model based on a self-attention mechanism that can process sequential data and capture long-distance dependency. The transformer architecture implements information transfer and processing through self-attention layers and feed forward neural network layers. The transformer-based diffusion model 118 uses the transformer as a backbone network for the diffusion model instead of traditional convolution neural networks (e.g., U-net) to handle the input latent representations.

In some implementations, the image-to-video generator 110 receives a request to generate a digital video from the computing device 104, e.g., via the application. The request, for instance, includes a digital image and in response to the request, the image-to-video generator 110 inputs the digital image into the transformer-based diffusion model 118. The digital image may be representative of a video frame 114 of a set of video frames. In one or more examples, the video frame 114 is an initial video frame (or first video frame) of the set of video frames. That is, the initial video frame comes before the other video frames in the set of video frames in these one or more examples.

In addition to the video frame 114, the request includes at least locations 116. For example, the request includes an initial location 116 that defines a location in the initial video frame 114 and a target location 116 that defines a location in a target video frame of the set of video frames, e.g., a last video frame of the set of video frames. In response to the request, the image-to-video generator 110 identifies a location layout for the set of video frames. That is, the image-to-video generator 110 generates a location 116 for each video frame of the set of video frames (e.g., using linear interpolation between the initial location and the target location with some randomness). Using the location layout and the transformer-based diffusion model 118, the image-to-video generator 110 generates a video 120 that includes an object that follows a path of motion as defined by the location layout. That is, the object of the video is confined at least partially to the locations 116 of the set of frames. In some implementations, a location 116 is known as a bounding box which is represented by coordinates of its corners and is linked to region occupied by an object, e.g., a person, an animal, etc.

Prior to inputting the defined location layout into an attention block of the transformer-based diffusion model 118, the image-to-video generator 110 compresses the location 116. That is, the image-to-video generator 110 uses an encoder (e.g., a 3D VAE) to convert the locations (or bounding box coordinates) into latent representations. This allows the transformer-based diffusion model 118 to better understand the location constraints desired by the user. Other example parameters input in the attention block of the transformer-based diffusion model 118 include text prompts or images. The attention block is configurable to allow the transformer-based diffusion model 118 to generate a video that satisfies the parameters (e.g., text prompt, bounding boxes, images, etc.) desired by the user.

The techniques as described herein may also support removal or insertion of objects in the video 120. Removal refers to an object disappearing from the video 120. To support removal, the image-to-video generator 110 sets the location 116 of the target video frame to be located outside of a frame region of the last video frame. Insertion refers to inserting a new object in the video 120. In order to support complex motion, more than two locations 116 are input into the image-to-video generator 110. For example, locations 116 for frames between the initial video frame 114 and the target video frame 114 of the set of frames are input into the image-to-video generator 110.

The image-to-video generator 110 then passes the video 120 through a decoder to convert the video 120 from latent space back to pixel space. Upon generating the video 120, the image-to-video generator 110 stores the video 120 in one or more databases 122 of the digital provider system 102 and/or the image-to-video generator 110 transmit the video 120 to the computing device 104 via the network 106. Upon receiving the video 120, the computing device 104 then displays the video 120 to the user via the application 124.

In one or more examples, the image-to-video generator 110 trains the transformer-based diffusion model 118 using training data that includes multiple videos. When training aspects of the transformer-based diffusion model 118 related to object motion generation, the image-to-video generator 110 selectively identifies videos from the multiple videos to be included in the training data based on some criteria. For example, the image-to-video generator 110 selects videos that have a ratio between a location size and a video frame size above a threshold, videos that include an object whose motion is greater than a threshold distance between video frames, videos that include an object whose size is greater than a threshold size, etc. Additionally, the image-to-video generator 110 selects training data that includes videos with annotations. The training data for the transformer-based diffusion model 118 is stored at the databases 122. In some implementations, while training aspects of the transformer-based diffusion model 118 related to object motion generation, the image-to-video generator 110 freezes model parameters associated with other aspects of the transformer-based diffusion model 118 (e.g., text self-attention and image self-attention) frozen.

The following discussion describes a latent mask mechanism that is employed by techniques described herein.

### Example Latent Mask Mechanism

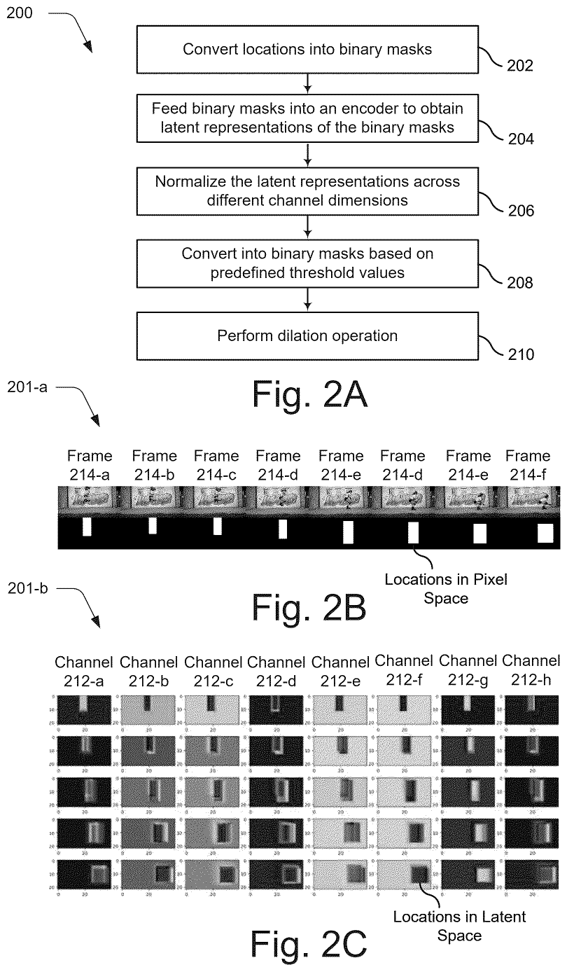

FIG. 2A illustrates an example of a flow 200 of one or more steps for generating locations in latent space that supports image-to-video generation using locations in digital images. In some implementations, the flow 200 is implemented by aspects of FIG. 1, 4, or 11. For example, the flow 200 is implemented by the image-to-video generator 110 or the processing device 402.

FIG. 2B illustrates an example of a location layout 201-a in pixel space that supports image-to-video generation using locations in digital images.

FIG. 2C illustrates an example of a location region layout 201-b in latent space that supports image-to-video generation using locations in digital images.

As described with reference to FIG. 1, an image-to-video generator 110 implements a latent mask mechanism to convert locations (or bounding box coordinates) to latent representations during image-to-video generation and prior to diffusion. Blocks 202 through 210 of flow 200 describe steps implemented by the image-to-video generator 110 to support the latent mask mechanism.

At (block 202), the image-to-video generator 110 converts a location (e.g., using bounding box coordinates) for each video frame 214 of a set of video frames 214 into binary mask representations, or v_{box}. FIG. 2B illustrates the set of video frames 214 (e.g., a video frame 214-a, a video frame 214-b, a video frame 214-c, a video frame 214-d, a video frame 214-e, and a video frame 214-f) and corresponding binary mask representations in pixel space. Black space of a binary mask representation, for instance, represents a first logic value (e.g., a logic value of zero) and white space, for instance, represents a second logic value, e.g., a logic value of one.

At (block 204), the image-to-video generator 110 feeds the binary mask representations into an encoder (e.g., a 3DVAE or E) to obtain corresponding latent representations (or h_{box}) as represented by Equation 1. FIG. 2C illustrates the latent representations of the binary mask representations, or the locations in latent space. Each column of FIG. 2C represents a different channel 212 of a set of channels 212, e.g., a channel 212-a, a channel 212-b, a channel 212-c, a channel 212-d, a channel 212-e, a channel 221-f, a channel 212-g, and a channel 212-h.

h_{box}=E(v_{box}) (1)

At (block 206), the image-to-video generator 110 normalizes the latent representations across different channel dimensions as represented by Equation 2. In some examples, the image-to-video generator 110 normalizes the latent representations across the different channel dimensions in a range of [0,1]. i represent an i-th channel of the latent representation.

$${h}_{b o x}^{i} = \frac{{h}_{b o x}^{i} - min ( {h}_{b o x}^{i} )}{max ( {h}_{b o x}^{i} ) - min ( {h}_{b o x}^{i} )} \qquad ( 2 )$$

At (block 208), the image-to-video generator 110 converts the latent representations into binary masks based on a predefined threshold value (or t) as represented by Equation 3.

$${h}_{b o x}^{i} = 𝕀 ( {h}_{b o x}^{i} \geq {τ}^{i} ) \qquad ( 3 )$$

At (block 210), the image-to-video generator 110 subjects the binary masks to a dilation operation with defined kernel size (or k) as represented by Equation 4.

$${h}_{box}^{i} = dilation ( {h}_{b o x}^{i} , {k}^{i} ) \qquad ( 4 )$$

The image-to-video generator 110, in at least one implementation, uses the first channel (e.g., the channel 212-a) as the channel for the latent mask mechanism. Further, the image-to-video generator 110 sets a value of the threshold (or τ) to 50/255 and a value of the kernel size (or k) to 3 for the latent mask mechanism. Using these values for the channel, threshold, and kernel size yields better results when compared to using other values. The image-to-video generator 110 is configurable to implement the latent mask mechanism prior to the diffusion process. Because the image-to-video generator 110 converts video frames from pixel space to latent space prior to diffusion, implementing the latent mask mechanism allows the image-to-video generator 110 to better understand a relationship between the latent video frames the locations when generating the desired video.

The following discussion describes a location cross-attention layer that is employed by techniques described herein.

### Example Location Cross-Attention Layer

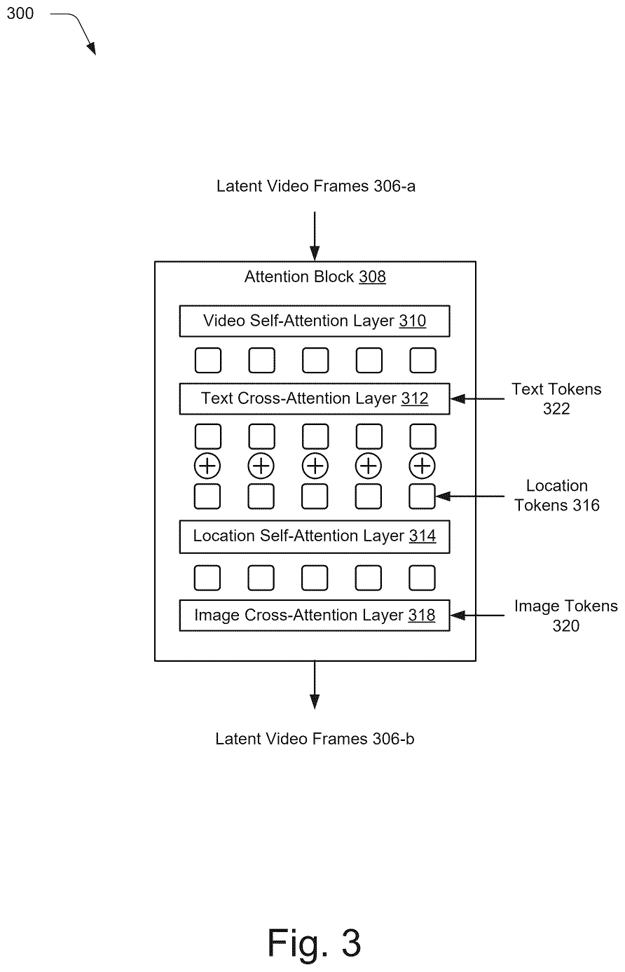

FIG. 3 illustrates an example of a model architecture 300 that supports image-to-video generation using locations in digital images. In some implementations, the model architecture 300 is implemented by aspects of FIGS. 1, 4, and 11. For example, the model architecture 300 is implemented by the image-to-video generator 110 as executed by the processing device 402.

As described herein, the transformer-based diffusion model 118 generates a video from an initial frame image and using locations of a set of video frames including the initial frame image. To generate the video, the transformer-based diffusion model 118 performs a denoising process on noisy latent video frames 306-a. During the denoising process, the transformer-based diffusion model 118 inputs the noisy latent video frames 306-a in an attention block 308 of the transformer-based diffusion model 118. As illustrated in FIG. 3, the attention block 308 includes a video self-attention layer 310, a text cross-attention layer 312, a location self-attention layer 314, and an image cross-attention layer 318. At the attention block, the transformer-based diffusion model 118 aligns the noisy latent video frames 306-a with input text, input locations, and input key frame images to generate denoised latent video frames 306-b.

The attention block 308 is formulated according to Equations 5-8. In Equations 5-8, vₜ represents video visual tokens of the noisy latent video frames 306-a, hₜₑₓₜ represents text tokens 322, h_{images} represent key-frame image tokens 320, h_{box} represents location tokens 316, CAT( ) denotes a token concatenation operation, and MLP( ) denotes a multi-later perceptron.

At the location self-attention layer 314 and using the CAT( ) function, the transformer-based diffusion model 118 concatenates the video visual tokens with the location tokens 316 along a channel dimension and uses the MLP( ) to map the concatenated tokens back to original channel dimensions. In some implementations, the location tokens 316 include latent representations related to one or more objects. It is understood that location tokens 316 (or h_{box}) are associated with one or multiple objects. For example,

$${h}_{b o x} = [ {h}_{box}^{1} , {h}_{b o x}^{2} , … , {h}_{b o x}^{N} ] ,$$

where N is a maximum number of objects for each video. If the number of objects is few than N, a fixed null

$${h}_{b o x}^{n u l l}$$

are used to pad the empty slots.

$${v}_{t} = {v}_{t} + SelfAtt n ( {v}_{t} ) \qquad ( 5 )$$

$${v}_{t} = {v}_{t} + C r o s s A t t n ( {v}_{t} , {h}_{text} ) \qquad ( 6 )$$

$${v}_{t} = {v}_{t} + SelfAttn ( ML P ( C A T ( [ {v}_{t} , {h}_{box} ] ) ) ) \qquad ( 7 )$$

$${v}_{t} = {v}_{t} + C r o s s ( {v}_{t} , {h}_{i m a g e s} ) \qquad ( 8 )$$

In some implementations, the image-to-video generator 110 independently trains the location self-attention layer 314 of the transformer-based diffusion model 118. That is, the image-to-video generator 110 freezes parameters associated with other layers of the attention block 308 (e.g., the video self-attention layer 310, the text cross-attention layer 312, and the image cross-attention layer 318) while training the location self-attention layer 314. The image-to-video generator 110 trains the transformer-based diffusion model 118 using a diffusion loss to predict noise added at each step (or t) as shown in Equation 9. In Equation 9, v₀ represents the ground truth video latent, e is a Gaussian noise vector and ∈_{θ,θ′} denotes the transformer-based diffusion model 118, where θ are parameters of the location self-attention layer 314 and θ′ are other parameters of the transformer-based diffusion model 118. As described above, θ′ is frozen, while θ is optimized during training.

$${ℒ}_{θ} = {\text{?}}_{{v}_{0} , ϵ , t , {h}_{text} , {h}_{image} , {h}_{box}} [ {‖ ϵ - {ϵ}_{θ , {θ}^{′}} ( {v}_{t} , t , {h}_{text} , {h}_{image} , {h}_{box} ) ‖}_{2}^{2} ] \qquad ( 9 )$$

The image-to-video generator 110 then selects training data for training the location self-attention layer 314 based on one or more criteria. For example, the image-to-video generator 110 selects videos without an initial frame image such that the transformer-based diffusion model focuses on location information. Additionally, or alternatively, the image-to-video generator 110 selects videos with annotations. Additionally, or alternatively, the image-to-video generator 110 selects videos where a ratio between locations of the video and a video frame size of the video satisfies a range (e.g., a range of [0.04, 0.7]) to ensure that objects of the videos are of suitable size, e.g., the size of the objects in the video satisfies a threshold.

Additionally, or alternatively, the image-to-video generator 110 selects videos that include objects whose motion is greater than a threshold distance between video frames of the videos, e.g., greater than 0.01. motion of an object is measured by a movement of the location of the object, e.g., movement of four corners of a bounding box or a center of the bounding box. The image-to-video generator 110 is configurable to measure a motion of the objects after normalizing height and width of the location of the objects to a range of [0,1] relative to the video frame dimensions.

The following discussion describes an example processing device that employs the techniques described herein.

### Example Device

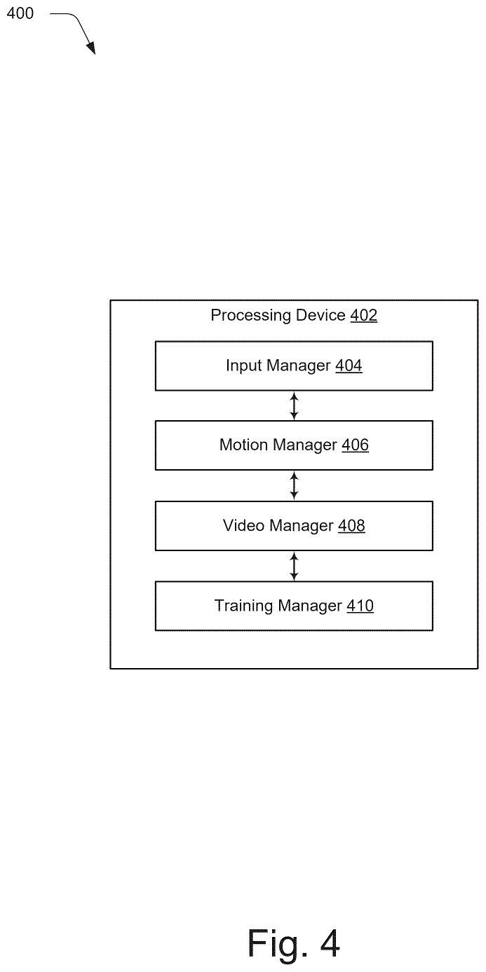

FIG. 4 illustrates an example of a component diagram 400 that supports image-to-video generation using locations in digital images. In some implementations, the processing device 402 is an example of the image-to-video generator 110 as described with reference to FIG. 1. The processing device 402, or various components thereof, are an example of means for performing various aspects of image-to-video generation using locations in digital images described herein. For example, the processing device 402 includes an input manager 404, a motion manager 406, a video manager 408, and a training manager 410. Each of these components communicate, directly or indirectly, with one another.

In some implementations, the input manager 404, the motion manager 406, the video manager 408, and the training manager 410 are implemented in code (e.g., as software or firmware) executed by a processor. If implemented in code executed by a processor, the functions of the input manager 404, the motion manager 406, the video manager 408, and the training manager 410 are performed by a general-purpose processor, a DSP, a CPU, an ASIC, an FPGA, a microcontroller, or any combination thereof.

The input manager 404 is capable of, configured to, or operable to support a means for receiving an input defining an initial location in an initial video frame and a target location in a target video frame. The motion manager 406 is capable of, configured to, or operable to support a means for determining, for a set of intermediary video frames, a set of intermediary locations as exhibiting movement between the initial location and the target location. The video manager 408 is capable of, configured to, or operable to support a means for generating a digital video that includes an object as disposed at the initial location in the initial video frame, the set of intermediary locations in the set of intermediary video frames, and the target location in the target video frame using a transformer-based diffusion model.

In some implementations, the motion manager 406 is further capable of, configured to, or operable to support a means for converting the initial location, the target location, and the set of intermediary locations into binary masks. In some implementations, the motion manager 406 is further capable of, configured to, or operable to support a means for generating, using a three-dimensional variational autoencoder, latent representations of the binary masks. In some implementations, the motion manager 406 is further capable of, configured to, or operable to support a means for inputting the latent representations into the transformer-based diffusion model.

In some implementations, the training manager 410 is capable of, configured to, or operable to support a means for training the transformer-based diffusion model to generate the digital video based on the initial location, the target location, and the set of intermediary locations. In some implementations, the training manager 410 is further capable of, configured to, or operable to support a means for selecting digital videos for training the transformer-based diffusion model based on one or more criteria. The training manager 410 is further capable of, configured to, or operable to support a means for selecting digital videos that include annotations, selecting digital videos that include a respective object that satisfies a size threshold, selecting digital videos that includes a respective object that moves at least a threshold distance between video frames, or a combination thereof. The training manager 410 is also capable of, configured to, or operable to support a means for freezing one or more model parameters of the transformer-based diffusion model while training the transformer-based diffusion model using the selected digital videos.

The following discussion describes video generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-4.

### Example Video Generation Procedures

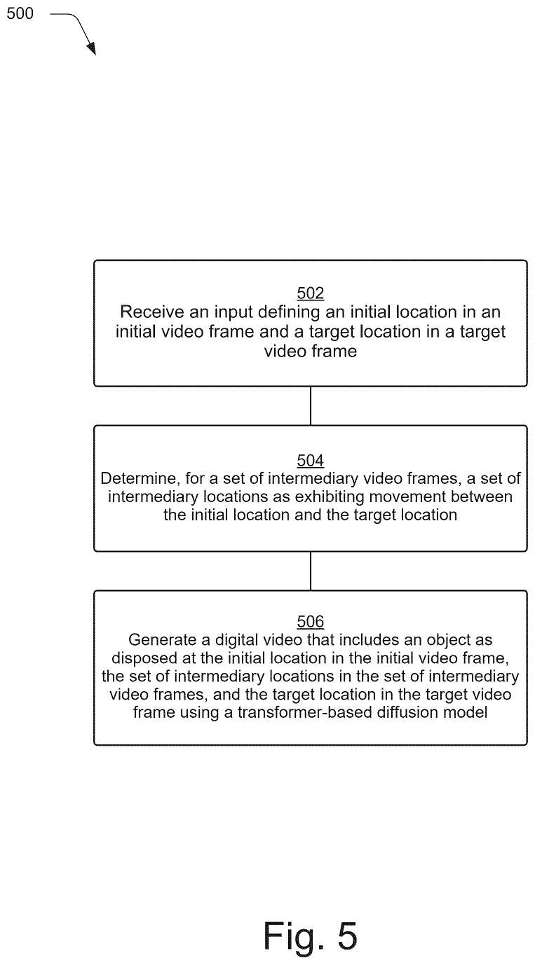

FIG. 5 illustrates an example of a procedure 500 that supports image-to-video generation using locations in digital images. In some examples, the procedure 500 is implemented by aspects of FIG. 1, 4, or 11. For example, the procedure is implemented by the image-to-video generator 110 or the processing device 402. It should be noted that the procedure 500 described herein describes a possible implementation, and that the operations and the steps are rearranged or otherwise modified and that other implementations are possible.

At (block 502), the image-to-video generator 110 receives an input defining an initial location in an initial video frame and a target location in a target video frame.

At (block 504), the image-to-video generator 110 determines, for a set of intermediary video frames, a set of intermediary locations as exhibiting movement between the initial location and the target location.

In some implementation, the image-to-video generator 110 converts the initial location, the target location, and the set of intermediary locations into binary masks. In some implementations, the image-to-video generator 110 generates, using a 3DVAE, latent representations of the binary masks. In some implementations, the image-to-video generator 110 inputs the latent representations into the transformer-based diffusion model.

At (block 506), the image-to-video generator 110 generates a digital video that includes an object as disposed at the initial location in the initial video frame, the set of intermediary locations in the set of intermediary video frames, and the target location in the target video frame using a transformer-based diffusion model.

In some implementations, the image-to-video generator 110 trains the transformer-based diffusion model to generate the digital video based on the initial location, the target location, and the set of intermediary locations. In some implementations, the image-to-video generator 110 selects digital videos for training the transformer-based diffusion model based on one or more criteria. In some implementations, the image-to-video generator 110 selects digital videos that include annotations, selects digital videos that include a respective object that satisfies a size threshold, selects digital videos that includes a respective object that moves at least a threshold distance between video frames, or a combination thereof. In some implementations, the image-to-video generator 110 freezes one or more model parameters of the transformer-based diffusion model while training the transformer-based diffusion model using the selected digital videos.

### Example Architecture

FIG. 6 illustrates a guided diffusion model 600 that supports image-to-video generation using locations in digital images. The guided diffusion model 600 depicted in FIG. 6 is an example of, or includes aspects of, the transformer-based diffusion model 118 as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 600 takes an original media item 605 in a pixel space 610 as input and apply forward diffusion process 615 to gradually add noise to the original media item 605 to obtain noisy media item 620 at various noise levels.

Next, a reverse diffusion process 625 gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Techniques of operating diffusion models include a Denoising Diffusion Probabilistic Model (DDPM) and a Denoising Diffusion Implicit Models, or DDIM. In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models are also characterized by whether the noise is added to the media item itself, or to media features generated by an encoder, i.e., latent diffusion. In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Example Conditional Generation Inference

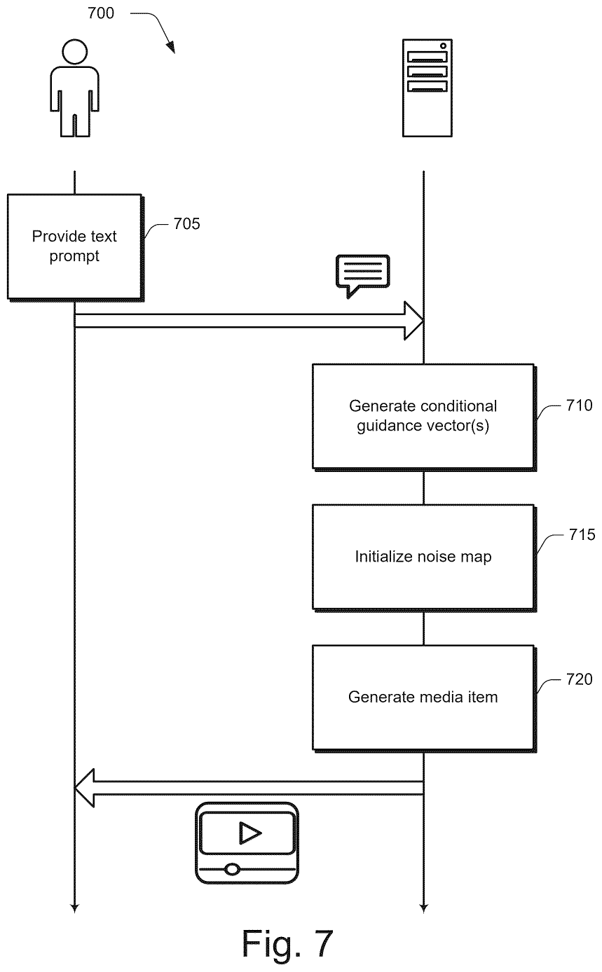

FIG. 7 illustrates a method 700 that supports image-to-video generation using locations in digital images. In some implementations, method 700 describes an operation of the transformer-based diffusion model 118 as described with reference to FIG. 1 such as an application of the guided diffusion model 600 described with reference to FIG. 6. In some implementations, these operations are performed by a system including a processor executing a set of codes to control functional elements of an apparatus such as the media generation model described in FIG. 6.

Additionally, or alternatively, steps of the method 700 is performed using special-purpose hardware. Generally, these operations are performed according to the methods and processes described in accordance with aspects of the present disclosure. In some cases, the operations described herein are composed of various substeps, or are performed in conjunction with other operations.

At operation 705, a user provides a text prompt describing content to be included in a generated media item. For example, a user provides the prompt “a person playing with a cat”. In some implementations, guidance can be provided in a form other than text, such as via an image, a sketch, or a layout.

At operation 710, the system converts the text prompt (or other guidance) into a conditional guidance vector or other multi-dimensional representation. For example, text is converted into a vector or a series of vectors using a transformer model, or a multi-modal encoder. In some cases, the encoder for the conditional guidance is trained independently of the diffusion model.

At operation 715, a noise map is initialized that includes random noise. The noise map is in a pixel space or a latent space. By initializing a media item with random noise, different variations of a media item including the content described by the conditional guidance can be generated.

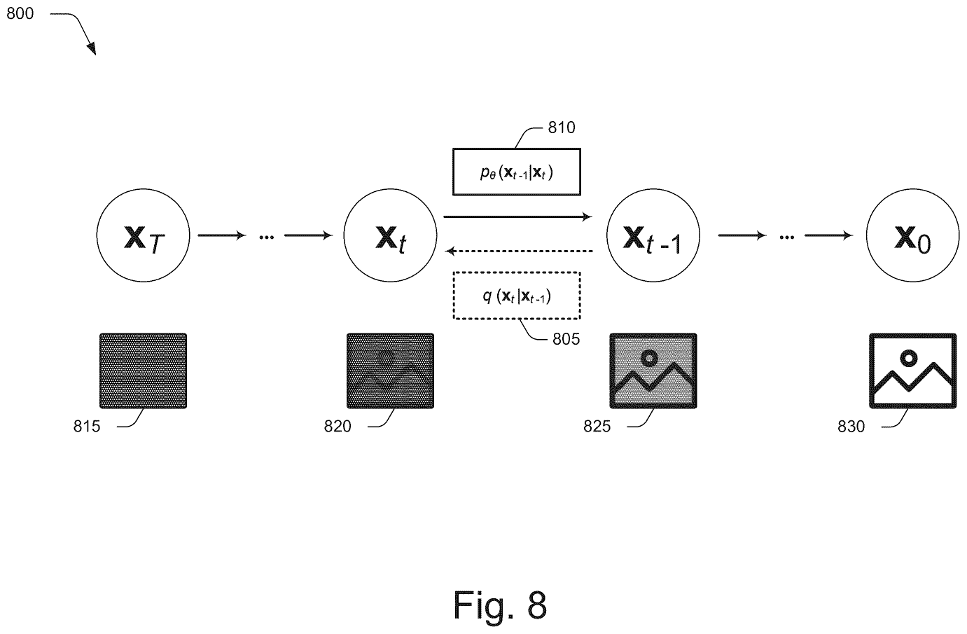

At operation 720, the system generates a media item based on the noise map and the conditional guidance vector. For example, the media item is generated using a reverse diffusion process as described with reference to FIG. 8.

### Example Reverse Diffusion Inference

FIG. 8 illustrates a diffusion process 800 that that supports image-to-video generation using locations in digital images. In some implementations, diffusion process 800 describes an operation of the transformer-based diffusion model 118 described with reference to FIG. 1, such as the reverse diffusion process 625 of guided diffusion model 600 described with reference to FIG. 6.

As described above with reference to FIG. 6, using a diffusion model can involve both a forward diffusion process 805 for adding noise to a media item (or features in a latent space) and a reverse diffusion process 810 for denoising the media item (or features) to obtain a denoised media item. The forward diffusion process 805 can be represented as q(xₜ|xₜ₋₁), and the reverse diffusion process 810 can be represented as p (xₜ₋₁|xₜ). In some cases, the forward diffusion process 805 is used during training to generate media items with successively greater noise, and a neural network is trained to perform the reverse diffusion process 810, i.e., to successively remove the noise.

In an example forward process for a latent diffusion model, the model maps an observed variable x, (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network, where x₁, . . . , x_{T} have the same dimensionality as x₀.

The neural network is trained to perform the reverse process. During the reverse diffusion process 810, the model begins with noisy data x_{T}, such as a noisy media item 815 and denoises the data to obtain the p(xₜ₋₁|xₜ). At each step t−1, the reverse diffusion process 810 takes xₜ, such as first intermediate media item 820, and t as input. Here, t represents a step in the sequence of transitions associated with different noise levels, The reverse diffusion process 810 outputs xₜ₋₁, such as second intermediate media item 825 iteratively until x_{T} reverts back to x₀, the original media item 830. The reverse process can be represented as:

P_{θ}(xₜ₋₁|xₜ):=N(xₜ₋₁;μ_{θ}(xₜ,t),Σ_{θ}(xₜ,t)) (10)

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) \qquad ( 11 )$$

where p(x_{T})=N(x_{T}; 0,1) is the pure noise distribution as the reverse process takes the outcome of the forward process, a sample of pure noise, as input and

$${Π}_{t = 1}^{T} {p}_{θ} ( {x}_{t - 1} \vert {x}_{t} )$$

represents a sequence of Gaussian transitions corresponding to a sequence of addition of Gaussian noise to the sample. At interference time, observed data x₀ in a pixel space can be mapped into a latent space as input and a generated data \tilde{x} is mapped back into the pixel space from the latent space as output. In some implementations, x, represents an original input media item with low quality, latent variables x₁, . . . , x_{T} represent noisy media items, and ã represents the generated item with high quality.

### Example Training of Machine Learning Model

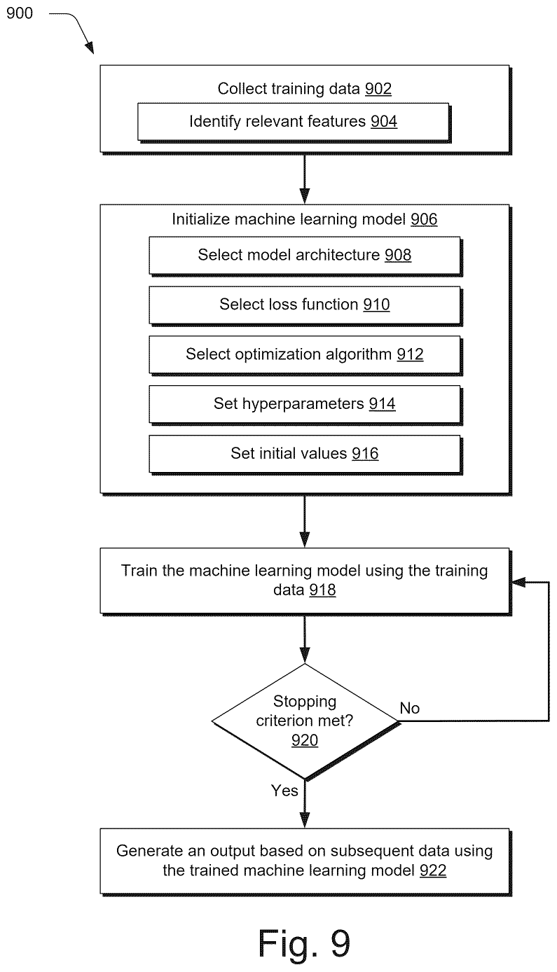

FIG. 9 illustrates a procedure 900 that that supports image-to-video generation using locations in digital images. In some implementations, the procedure 900 describes an operation of the training described for configuring the transformer-based diffusion model 118 as described with reference to FIG. 1. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection also includes data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized, block 906. Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected, block 910. The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including multiple nodes that collectively form multiple layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data, block 922. The trained machine-learning model, for instance, is trained to perform a task as described above and therefore once trained is configured to perform that task based on subsequent data received as an input and processed by the machine-learning model.

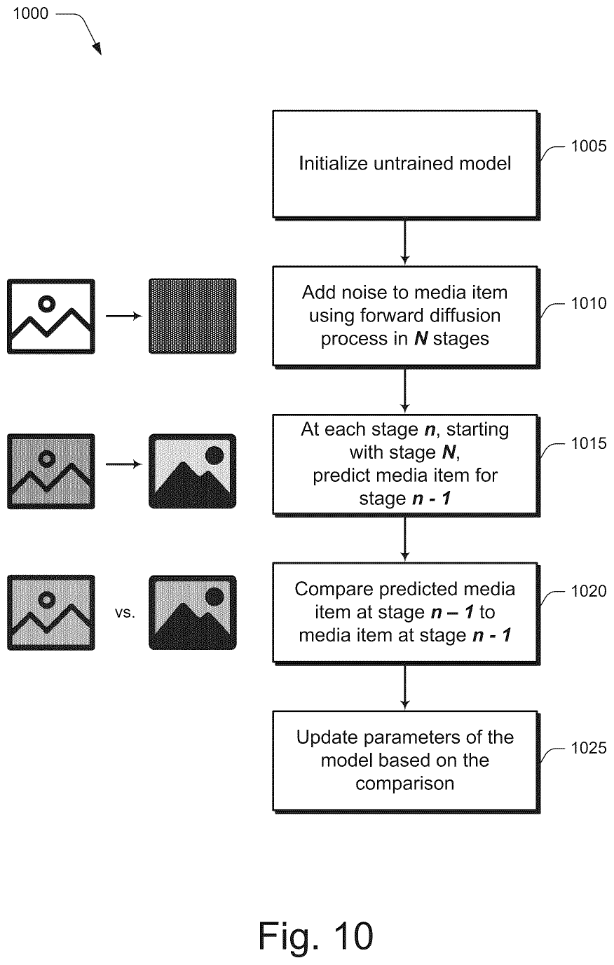

FIG. 10 illustrates an example of a method 1000 that supports image-to-video generation using locations in digital images. In some implementations, the method 1000 describes an operation of training described for configuring the transformer-based diffusion model 118 as described with reference to FIG. 1. The method 1000 represents an example for training a reverse diffusion process as described above with reference to FIG. 8. In some implementations, these operations are performed by a system including a processor executing a set of codes to control functional elements of an apparatus, such as the guided diffusion model described in FIG. 6.

Additionally, or alternatively, certain processes of method 1000 are performed using special-purpose hardware. Generally, these operations are performed according to the methods and processes described in accordance with aspects of the present disclosure. In some cases, the operations described herein are composed of various sub-steps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a media item using a forward diffusion process in N stages. In some cases, the forward diffusion process is a fixed process where Gaussian noise is successively added to media item. In latent diffusion models, the Gaussian noise is successively added to features in a latent space.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model is trained to minimize the variational upper bound of the negative log-likelihood-log pe (x) of the training data.

At operation 1025, the system updates parameters of the model based on the comparison. Time-dependent parameters of the Gaussian transitions can also be learned.

### Example System and Device

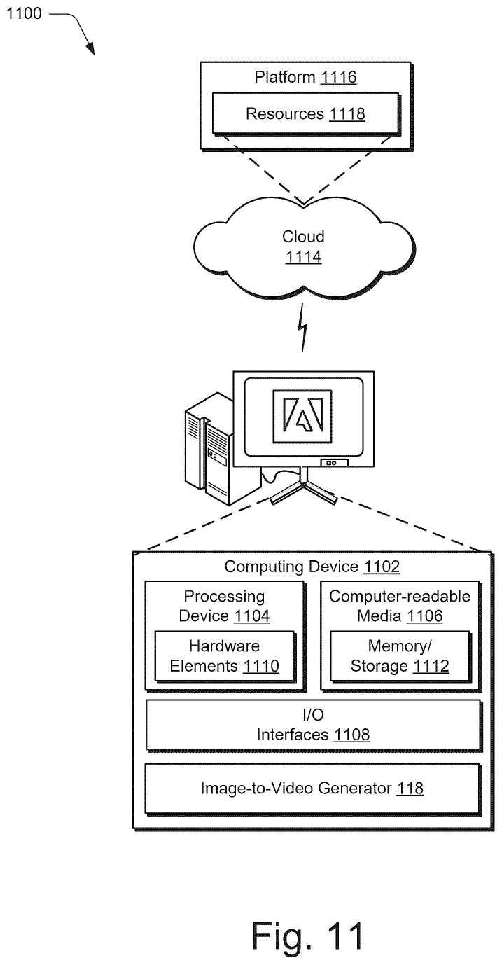

FIG. 11 illustrates an example system 1100 that includes an example computing device 1102 that is representative of one or more computing systems and/or devices that are usable to implement the various techniques described herein. This is illustrated through the inclusion of the image-to-video generator 110. The computing device 1102 is configurable, for example, as a server of a service provider, a device associated with a client (e.g., a client device), an on-chip system, and/or any other suitable computing device or computing system.

The example computing device 1102, as illustrated, includes a processing device 1104, one or more computer-readable media 1106, and one or more I/O interfaces 1108 that are communicatively coupled, one to another. Although not shown, the computing device 1102 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing device 1104 is representative of the functionality to perform one or more operations using hardware. Accordingly, the processing device 1104 is illustrated as including hardware elements 1110 that are configured as processors, functional blocks, and so forth. This includes example implementations in hardware as an application specific integrated circuit or other logic device formed using one or more semiconductors. The hardware elements 1110 are not limited by the materials from which the hardware elements 1110 are formed or the processing mechanisms employed therein. For example, processors include semiconductor(s) and/or transistors, e.g., electronic integrated circuits, or ICs. In such a context, processor-executable instructions are, for example, electronically-executable instructions.

The computer-readable media 1106 is illustrated as including memory/storage 1112. Memory/storage 1112 represents memory or storage capacity associated with one or more computer-readable media. In one example, the memory/storage 1112 includes volatile media (such as random access memory (RAM)) and/or nonvolatile media, such as read-only memory (ROM), Flash memory, optical disks, magnetic disks, and so forth. In another example, the memory/storage 1112 includes fixed media (e.g., RAM, ROM, a fixed hard drive, and so on) as well as removable media, e.g., Flash memory, a removable hard drive, an optical disc, and so forth. The computer-readable media 1106 is configurable in a variety of other ways, as further described below.

Input/output interface(s) 1108 are representative of functionality to allow a user to enter commands and information to computing device 1102 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 1102, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic, and/or fixed device logic implemented in a hardware form that is employable in some implementations to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 1110. For example, the computing device 1102 is configured to implement particular instructions and/or functions corresponding to the software and/or hardware modules. Accordingly, implementation of a module that is executable by the computing device 1102 as software is achieved at least partially in hardware, e.g., through the use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supportable by various configurations of the computing device 1102 and are not limited to the specific examples of the techniques described herein. This functionality is also implementable entirely or partially through the use of a distributed system, such as over a “cloud” 1114, as described below.

The cloud 1114 includes and/or is representative of a platform 1116 for resources 1118. The platform 1116 abstracts the underlying functionality of hardware (e.g., servers) and software resources of the cloud 1114. For example, the resources 1118 include applications and/or data that are utilized while computer processing is executed on servers remote from the computing device 1102. In some implementations, the resources 1118 also include services provided over the Internet and/or through a subscriber network, such as a cellular or Wi-Fi network.

The platform 1116 abstracts the resources 1118 and functions to connect the computing device 1102 with other computing devices. In some implementations, the platform 1116 also serves to abstract scaling of resources to provide a corresponding level of scale to encountered demand for the resources implemented via the platform. Accordingly, in an interconnected device implementation, the implementation of functionality described herein is distributable throughout the system 1100. For example, the functionality is implementable in part on the computing device 1102 as well as via the platform 1116 that abstracts the functionality of the cloud 1114.

In general, functionality, features, and concepts described in relation to the examples above and below are employed in the context of the example procedures described in this section. Further, functionality, features, and concepts described in relation to different FIGS. and examples in this document are interchangeable among one another and are not limited to implementation in the context of a particular FIG. or procedure. Moreover, blocks associated with different representative procedures and corresponding FIGS. herein are applicable together and/or combinable in different ways. Thus, individual functionality, features, and concepts described in relation to different example environments, devices, components, FIGS., and procedures herein are usable in any suitable combinations and are not limited to the particular combinations represented by the enumerated examples in this description.

What is claimed is:

1. A method, comprising:
receiving, by a processing device, an input defining an initial location in an initial video frame and a target location in a target video frame;
determining, for a set of intermediary video frames by the processing device, a set of intermediary locations as exhibiting movement between the initial location and the target location; and
generating, by the processing device, a digital video that includes an object as disposed at the initial location in the initial video frame, the set of intermediary locations in the set of intermediary video frames, and the target location in the target video frame using a transformer-based diffusion model.

2. The method of claim 1, further comprising:
converting the initial location, the target location, and the set of intermediary locations into binary masks.

3. The method of claim 2, further comprising:
generating, using a three-dimensional variational autoencoder, latent representations of the binary masks.

4. The method of claim 3, further comprising:
inputting the latent representations into the transformer-based diffusion model, wherein generating the digital video is based on inputting the latent representations into the transformer-based diffusion model.

5. The method of claim 1, further comprising:
training the transformer-based diffusion model to generate the digital video based on the initial location, the target location, and the set of intermediary locations.

6. The method of claim 5, further comprising:
selecting digital videos for training the transformer-based diffusion model based on one or more criteria.

7. The method of claim 6, wherein selecting the digital videos based on the one or more criteria comprises:
selecting digital videos that include annotations;
selecting digital videos that include a respective object that satisfies a size threshold;
selecting digital videos that includes a respective object that moves at least a threshold distance between video frames; or
a combination thereof.

8. The method of claim 6, further comprising:
freezing one or more model parameters of the transformer-based diffusion model while training the transformer-based diffusion model using the selected digital videos.

9. A system comprising:
a memory component; and
one or more processing devices coupled to the memory component, the one or more processing devices to perform operations comprising:
receiving an input defining an initial location in an initial video frame and a target location in a target video frame;
determining, for a set of intermediary video frames, a set of intermediary locations as exhibiting movement between the initial location and the target location; and
generating a digital video that includes an object as disposed at the initial location in the initial video frame, the set of intermediary locations in the set of intermediary video frames, and the target location in the target video frame using a transformer-based diffusion model.

10. The system of claim 9, operations further comprising:
converting the initial location, the target location, and the set of intermediary locations into binary masks.

11. The system of claim 10, operations further comprising:
generating, using a three-dimensional variational autoencoder, latent representations of the binary masks.

12. The system of claim 11, operations further comprising:
inputting the latent representations into the transformer-based diffusion model, wherein generating the digital video is based on inputting the latent representations into the transformer-based diffusion model.

13. The system of claim 9, operations further comprising:
training the transformer-based diffusion model to generate the digital video based on the initial location, the target location, and the set of intermediary locations.

14. The system of claim 13, operations further comprising:
selecting digital videos for training the transformer-based diffusion model based on one or more criteria.

15. The system of claim 14, operations for selecting the digital videos based on the one or more criteria comprising:
selecting digital videos that include annotations;
selecting digital videos that include a respective object that satisfies a size threshold;
selecting digital videos that includes a respective object that moves at least a threshold distance between video frames; or
a combination thereof.

16. The system of claim 14, operations further comprising:
freezing one or more model parameters of the transformer-based diffusion model while training the transformer-based diffusion model using the selected digital videos.

17. A non-transitory computer readable medium storing executable instructions, which when executed by a processing device, cause the processing device to perform operations comprising:
receiving, by a processing device, an input defining an initial location in an initial video frame and a target location in a target video frame;
determining, for a set of intermediary video frames by the processing device, a set of intermediary locations as exhibiting movement between the initial location and the target location; and
generating, by the processing device, a digital video that includes an object as disposed at the initial location in the initial video frame, the set of intermediary locations in the set of intermediary video frames, and the target location in the target video frame using a transformer-based diffusion model.

18. The non-transitory computer readable medium of claim 17, operations further comprising:
converting the initial location, the target location, and the set of intermediary locations into binary masks.

19. The non-transitory computer readable medium of claim 18, operations further comprising:
generating, using a three-dimensional variational autoencoder, latent representations of the binary masks.

20. The non-transitory computer readable medium of claim 19, operations further comprising:
inputting the latent representations into the transformer-based diffusion model, wherein generating the digital video is based on inputting the latent representations into the transformer-based diffusion model.
